(19) United States
(12) Patent Application Publication
(10) Pub. No.: US 2020/0146911 A1
(43) Pub. Date: May 14, 2020

(54) Fall Assist Device

(71) Applicants: Nancy Whitlock, Wellton, AZ (US); Gary Whitlock, LeMars, IA (US)

(72) Inventors: Nancy Whitlock, Wellton, AZ (US); Gary Whitlock, LeMars, IA (US)

(21) Appl. No.: 16/682,076

(22) Filed: Nov. 13, 2019

Related U.S. Application Data
(60) Provisional application No. 62/760,396, filed on Nov. 13, 2018.

(51) Int. Cl. A61G 7/10

(52) U.S. Cl. CPC A61G 7/1011; A61G 7/1059; A61G 7/1038; A61G 7/1019

(57) ABSTRACT

A fall assist device including a scissor lift. The scissor lift is operated by either a motor or manual operation. The motor is an electric motor. The manual method of operation is completed using a handle. A hydraulic system can be used to help in operation of the scissor lift. The scissor lift, motor, power source, and hydraulic system are all located in a base of the fall assist device. A seat is attached to the scissor lift. A number of buttons are connected to the motor to operate the scissor lift. The buttons are located on an outer edge of the seat. A covering is added to the scissor lift. The covering is a flexible material that will rise and fall with the scissor lift.

### CROSS REFERENCE TO RELATED APPLICATIONS

This application claims the benefit of U.S. Provisional Application No. 62/760,396 filed on Nov. 13, 2018. The above identified patent application is herein incorporated by reference in its entirety to provide continuity of disclosure.

### BACKGROUND OF THE INVENTION

The present invention relates to a fall assist device. More particularly, the present invention provides a scissor lift that a person can sit on after they have fallen to the ground and activate a lift that will place them in a better position to stand.

It is a common occurrence for people to lose their balance and fall to the ground. Further, people trip over common household items regularly and fall to the ground. Even an overexcited pet can run into a person and knock them to the ground. In some instances, it can be extremely hard to regain one's feet after a fall.

Sometimes people fall and cannot get up. Elderly people especially can find themselves in the unfortunate predicament of falling to the ground and not being able to regain their feet. This can be an extremely dangerous issue. If the individual has no communication device or they are living alone, they can be on the ground for a lengthy period of time before someone comes to their aid. This time on the ground can compound any potential issue or injury. Further, a person may not be able to eat, drink, or use the restroom until they are helped back to a standing position.

People that are injured or in a wheelchair may find it difficult to regain their footing after sitting in a chair or on the floor. A person may need some assistance getting back to their feet. Many companies have started to make chairs that tilt forward in order to try to help people to their feet. These chairs, however, only adjust forward and rarely move other parts of the chairs. Further, these chairs can be extremely costly.

Consequently, there is a need in for an improvement in the art of fall assist devices. The present invention substantially diverges in design elements from the known art while at the same time solves a problem many people face when they have fallen and cannot get up. In this regard the present invention substantially fulfills these needs.

### SUMMARY OF THE INVENTION

The present invention provides a fall assist device wherein the same can be utilized for providing convenience for the user when attempting to get back on their feet after they have fallen to the ground. The fall assist device comprises a base having a scissor lift attached thereto. A motor is coupled to the scissor lift, wherein the motor controls the movement of the scissor lift. A seat is coupled to a top of the scissor lift.

Another object of the fall assist device is to provide a fall assist device comprising a handle operably attached to the scissor lift, wherein the handle is configured to manually raise and lower the chair.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the fall assist device without a covering.

FIG. 2 shows a rear perspective view of an embodiment of the fall assist device with a motor and a battery compartment.

FIG. 3 shows a perspective view of an embodiment of the fall assist device with a handle and hydraulic system.

FIG. 4 shows a side view of an embodiment of the seat with control buttons located thereon.

FIG. 5 shows a perspective view of an embodiment of the fall assist device with a covering.

### DETAILED DESCRIPTION OF THE INVENTION

Reference is made herein to the attached drawings. Like reference numerals are used throughout the drawings to depict like or similar elements of the fall assist device. For the purposes of presenting a brief and clear description of the present invention, a preferred embodiment will be discussed as used for the fall assist device. The figures are intended for representative purposes only and should not be considered to be limiting in any respect.

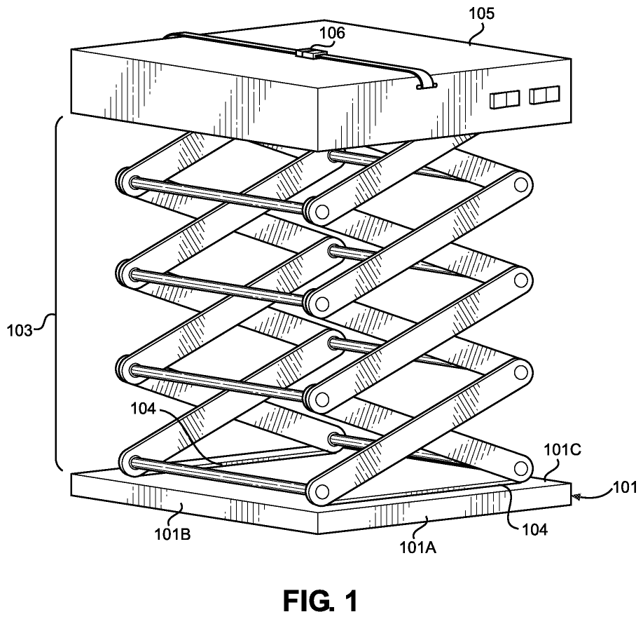

Referring now to FIG. 1, there is shown a perspective view of an embodiment of the fall assist device without a covering. The fall assistance device has a base 101. In one embodiment, the base 101 is a flat base. In another embodiment, the base 101 is a compartment. In this embodiment, the base 101 is made from a base plate 101A and sidewalls 101B rising therefrom. The sidewalls 101B will form an interior volume. The base 101 in this embodiment includes a top cover 101C enclosing the compartment. In one embodiment, the underside of the base 101 has at least one non-stick pad placed thereon.

A scissor lift 103 is attached to the base. The scissor lift 103 is capable of going from a collapsed configuration to an extended position. When the scissor lift 103 is collapsed the seat 105 will sit on the top of the base 101 and the scissor will fit under the seat 105. In one embodiment, the scissor lift 103 is attached to a pair of tracks 104 on the base 101. The pair of tracks 104 allow the connection to slide as the lift extends and retracts. In one embodiment, only one side of the scissor lift 103 is located in the tracks 104. In such an embodiment, the other half of the scissor lift 103 is hingedly attached to the base 101. This will allow the scissor lift 103 to extend and retract.

A seat 105 attached to the top of the scissor lift 103. In one embodiment, the seat 105 is a flat seat with a cushion. In one embodiment, the seat 105 is similar to a chair seat with a base and a back. In one embodiment, the seat 105 includes a seat belt 106 to ensure that a user does not fall from the seat 105 as the seat 105 is raised from the ground.

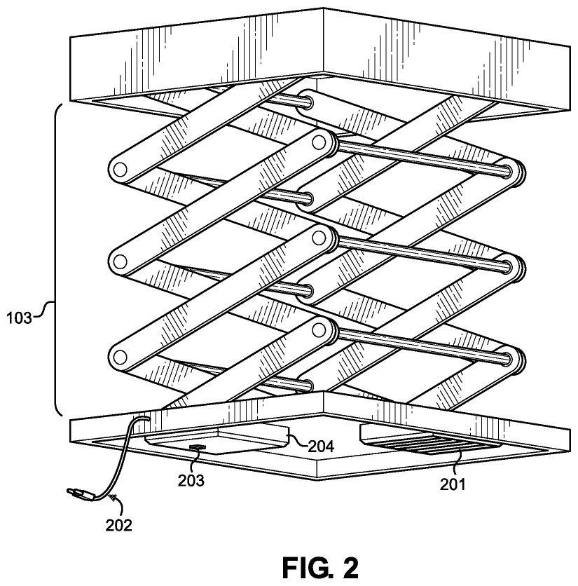

Referring now to FIG. 2, there is shown a rear perspective view of an embodiment of the fall assist device with a motor and a battery compartment. A motor 201 is attached to the scissor lift 103. The motor 201 is configured to raise and retract the scissor lift 103. In one embodiment, the motor 201 is mounted under the scissor lift 103 in the base. In another embodiment, the motor 201 is located next to the scissor lift 103 and attached to the base. In one embodiment, the motor 201 is an electric motor.

The motor 201 is operably coupled to a power source. In one embodiment, the power source is a power cord 202. In another embodiment, the power source is a battery 203. In the embodiment where the power source is a battery 203, the battery 203 is located in a battery compartment 204. The battery 203 has the ability to be charged via a wall plug 202. In one embodiment, there is a combination of power sources. This will allow the use of the fall assist device even if the power is out.

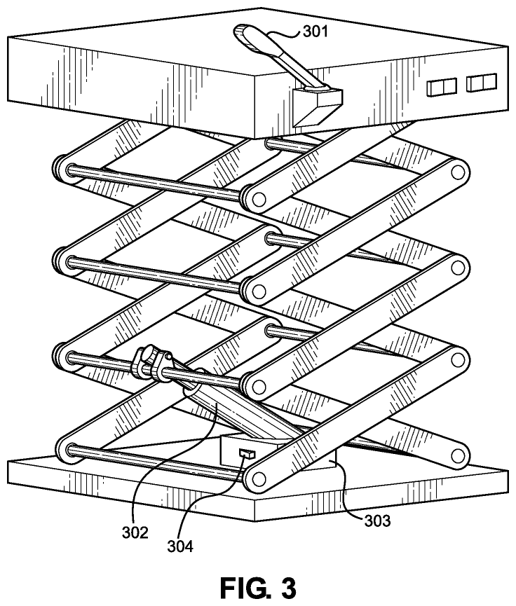

Referring now to FIG. 3, there is shown a perspective view of an embodiment of the fall assist device with a handle and hydraulic system. There is a handle 301 attached to a lifting system. In one embodiment, the handle 301 is a crank. The crank will allow the scissor lift 103 to be raised and retracted via manual pumping thereof.

In another embodiment, the handle 301 is coupled to a hydraulic system 302. The hydraulic system 302 includes a hydraulic pump 303 that is operably coupled to the handle 301. The hydraulic pump 303 is fluidly connected to an oil can which has hydraulic oil placed therein. When the handle 301 is pumped the hydraulic pump 303 will move oil to a solenoid and raise the scissor lift. In one embodiment, a switch 304 can be located on the hydraulic pump 303. The switch 304 will reverse the flow of the hydraulic pump 303. When the handle 301 pumps the hydraulic pump 303 in this configuration, the oil will be retracted from the solenoid and the scissor lift will retract.

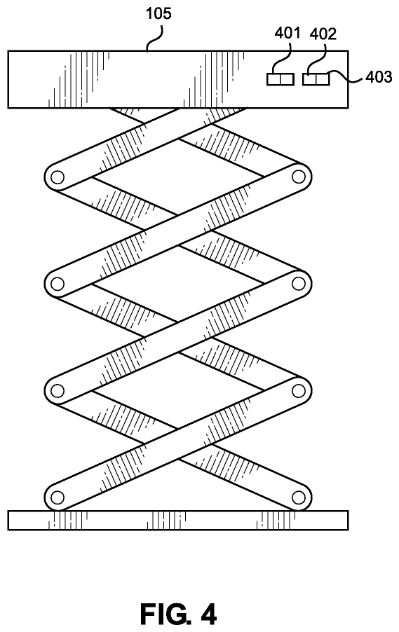

Referring now to FIG. 4, there is shown a side view of an embodiment of the seat with control buttons located thereon. In the illustrated embodiment, the seat 105 has a series of buttons located on the side of the seat. The buttons include at least a power button 401, an up button 402, and a down button 403. The buttons are operably coupled to the motor such that when they are pressed the motor is activated. In one embodiment, the up button 402 and the down button 403 are located on a toggle switch. The toggle switch can be actuated to move the scissor lift up and down when the power button 401 is pressed.

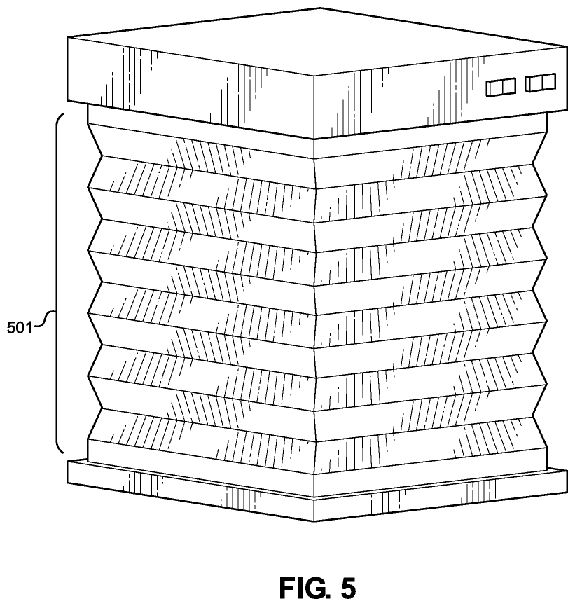

Referring now to FIG. 5, there is shown a perspective view of an embodiment of the fall assist device with a covering. The fall assist device has a covering 501 that is placed over the scissor lift. In one embodiment, the covering 501 is a cloth covering. In one embodiment, the covering 501 is a flexible rubber. In another embodiment, the covering 501 is a hinged together such that is folds when the scissor lift raises and retracts. The covering 501 can act as a safety measure to prevent an individual from getting a finger stuck therein. Further, the covering 501 is removable so to allow for access to the interior of the device.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1) A fall assist device, comprising:
a base having a scissor lift attached thereto;
a motor coupled to the scissor lift, wherein the motor controls the movement of the scissor lift;
a seat coupled to a top of the scissor lift.

2) The fall assist device of claim 1, further comprising a power source operably coupled to the motor.

3) The fall assist device of claim 2, wherein the power source is a wall plug.

4) The fall assist device of claim 2, wherein the power source is a battery.

5) The fall assist device of claim 4, wherein a battery compartment is attached to the base to store the battery.

6) The fall assist device of claim 1, further comprising a plurality of buttons located on the edge of the seat, wherein the buttons control the motor.

7) The fall assist device of claim 1, further comprising a covering placed around the scissor lift.

8) A fall assist device, comprising:
a base having a scissor lift attached thereto;
a motor coupled to the scissor lift, wherein the motor controls the movement of the scissor lift;
a seat coupled to a top of the scissor lift;
a handle operably attached to the scissor lift, wherein the handle is configured to manually raise and lower the seat.

9) The fall assist device of claim 8, further comprising a power source operably coupled to the motor.

10) The fall assist device of claim 9, wherein the power source is a wall plug.

11) The fall assist device of claim 9, wherein the power source is a battery.

12) The fall assist device of claim 11, wherein a battery compartment is attached to the base to store the battery.

13) The fall assist device of claim 8, further comprising a plurality of buttons located on the edge of the seat, wherein the plurality of buttons control the motor.

14) The fall assist device of claim 8, further comprising a housing placed around the scissor lift.

15) The fall assist device of claim 8, further comprising a hydraulic system operably coupled to the handle and the scissor lift, wherein the hydraulic system raises and lowers the scissor lift when the handle is actuated.
